(19) United States
(12) Patent Application Publication
(10) Pub. No.: US 2016/0242371 A1
(43) Pub. Date: Aug. 25, 2016

(54) FLEXIBLE POLYURETHANE FOAMS COMPRISING PLANT SEEDS

(71) Applicant: BASF SE, Ludwigshafen (DE)

(72) Inventor: Frank PRISSOK, Lemfoerde (DE)

(73) Assignee: BASF SE, Ludwigshafen (DE)

(21) Appl. No.: 14/442,540

(22) PCT Filed: Nov. 12, 2013
(86) PCT No.: PCT/EP2013/073616

§ 371 Date: May 13, 2015

(30) Foreign Application Priority Data
Nov. 13, 2012 (EP) 12192355.1

(51) Int. Cl. A01G 31/00; A01C 1/04; C08G 18/66; C08G 18/76; C08G 18/48; A01G 1/00; C08G 18/72

(52) U.S. Cl. CPC A01G 31/001; A01G 1/001; A01C 1/046; A01G 1/005; C08G 18/725; C08G 18/7664; C08G 18/4808; C08G 18/6674; A01G 2031/003; A01G 2031/007; Y02B 80/32; Y02P 60/216; C08G 2101/0008

(57) ABSTRACT

The invention relates to a flexible polyurethane foam comprising viable and/or germinated plant seeds. The flexible polyurethane foam may comprise a reinforcing fabric composed of fibers, for example synthetic-polymer fibers or rottable natural fibers. The flexible polyurethane foam may further comprise a substance having high water-holding capacity, for example a polyacrylate-based superabsorbent. By way of plant seeds the flexible polyurethane foam may comprise seeds of grasses, mosses, lichens, ferns, fungi, aquatic plants, flowering plants and perennial woody plants. The flexible polyurethane foam is obtained by mixing (a) polyisocyanates with (b) at least one comparatively high molecular weight compound having at least two reactive hydrogen atoms, (c) optionally low molecular weight chain-extending agents and/or crosslinking agents, (d) catalysts, (e) blowing agents, (f) optionally other added-substance materials and (g) plant seeds and reacting the mixture to form the flexible polyurethane foam. To vegetate areas, the flexible polyurethane foam in the form of a finite or continuous sheet is laid on the area or firmly bonded thereto and irrigated. This permits vegetation of exteriors, roof areas, rocky soils, sound-absorbing barriers and desert floors. A flexible polyurethane foam comprising viable and/or germinated lawn seed can be used as rolled sod.

The present invention relates to a flexible polyurethane foam comprising viable and/or germinated plant seeds, a method of producing said foam, a method of using said foam and a method of vegetating areas by using said flexible polyurethane foam.

Seeds applied to vertical or horizontal surfaces exposed to high winds and drought cannot be germinated directly at their site of application, since they would be blown away. Even applied in encapsulated form or within a loose fabric, seeds cannot be germinated in a vertical position since root attachment is impossible and no continuity of water supply is ensured.

Vegetation projects at tricky locations are therefore typically carried out on specially prepared soils with pregerminated (i.e., already germinated) plants in suitably receptacled substrates, for example peat or potting compost, which may further comprise fertilizer and water-storing materials in order that some water retention may be achieved between irrigations.

It is an object of the present invention to provide novel solutions for

(i) the vegetating of horizontal surfaces exposed to special climatic or mechanical stresses, such as arid zones, deserts, high-wind regions, stony, rocky territories with no or little sand or humus to permit autogenous rooting of germinated seeds;

(ii) the vegetating of vertical surfaces, such as exteriors, walls, cliffs, dikes and protective structures where any plant growth has hitherto only been possible in plant dishes or in niches.

We have found that this object is achieved by a flexible polyurethane foam comprising viable and/or germinated plant seeds.

It was found that, surprisingly, plant seeds, for example grass seeds, foamed into an open-cell polyurethane foam reacting at low temperature are viable after the foaming reaction. As long as the seeds are kept dry, they are storable; when stored under moist conditions or on watering they germinate in the polyurethane foam to form a dense layer of vegetation. When the polyurethane foam is cut into finite or continuous sheets, these can be applied horizontally as plant carpets or for rapid securement of levees or dikes. Installed vertically, they can function as exterior wall vegetation and temperature or humidity regulators indoors or out. Installed horizontally, they can function as a particularly hard-wearing substitute for rolled sod. The incorporation of reinforcing fabrics composed of nylon fiber, for example, in the foam makes it possible to improve the load-bearing capacity and tensile strength of the foam mats such that they are able to overbridge several meters in the vertical direction. Droplet irrigation is possible by virtue of the good absorbency of the open-cell polyurethane foam; plant nutrients and also fertilizer can be introduced via the irrigation water or in the event of a large-area application inC comparatively moist environments, even in the course of the foaming process.

The object is further achieved by a method of producing flexible polyurethane foams comprising viable plant seeds, which comprises mixing (a) polyisocyanates with (b) at least one comparatively high molecular weight compound having at least two reactive hydrogen atoms, (c) optionally low molecular weight chain-extending agents and/or crosslinking agents, (d) catalysts, (e) blowing agents, (f) optionally other added-substance materials and (g) plant seeds and reacting the mixture to form the flexible polyurethane foam.

The key to preserving the viability of the plant seeds is a sufficiently low reaction temperature of the foam. The maximum reaction temperature at which the plant seed still remains viable is greatly dependent on the seed species. In general, this maximum temperature is equal to 80° C. The temperature in the interior of the foam can be influenced not only via the formulation (prereacted prepolymer, level of secondary OH groups in the polyol component), and the reaction procedure (catalyst type and quantity) but also via the thickness of the mat or slabstock foam to be produced. Since the foam essentially serves to immobilize the seed grains, very good mechanical properties are rather less important for the foam. Good root penetration of the foam is more important alongside a low maximum temperature. Soil-destroying constituents, such as metal catalysts or plant-toxic constituents as well as herbicides, fungicides, bacteriocides and preservatives for the foam must be avoided in order that plant growth may not be impaired. The degree of root penetration is directly proportional to the open-cell content of the foam. The water-holding capacity can be influenced via the cellular fineness, the open-cell content as well as hydrophilic formulation ingredients and additives, such as zeolites, superabsorbents or, in general, water-swellable substances.

Flexible polyurethane foams for the purposes of the present invention are polyisocyanate polyaddition products comprising foamed materials as defined in DIN 7726 and having a DIN 53 421/DIN EN ISO 604 compressive stress at 10% compression or, respectively, compressive strength of 15 kPa or less, preferably in the range from 1 to 14 kPa and especially in the range from 4 to 14 kPa. Flexible polyurethane foams for the purposes of the present invention preferably have a DIN ISO 4590 open-cell content of greater than 85%, more preferably greater than 90%.

Polyisocyanate component (a) used for producing the flexible polyurethane foams of the present invention comprises any polyisocyanates known for polyurethane production. These comprise the prior art aliphatic, cycloaliphatic and aromatic di- or polyfunctional isocyanates and also any desired mixtures thereof. Examples are 2,2′-, 2,4′- and 4,4′-diphenylmethane diisocyanate, the mixtures of monomeric diphenylmethane diisocyanates and more highly nuclear homologs of diphenylmethane diisocyanate (polymer MDI), 2,4- or 2,6-tolylene diisocyanate (TDI) or mixtures thereof, tetramethylene diisocyanate or its oligomers, hexamethylene diisocyanate (HDI) or its oligomers, naphthylene diisocyanate (NDI) or mixtures thereof.

Preference is given to using 2,2′-, 2,4′- and 4,4′-diphenylmethane diisocyanate, the mixtures of monomeric diphenylmethane diisocyanates and more highly nuclear homologs of diphenyl-methane diisocyanate (polymer MDI), 2,4- or 2,6-tolylene diisocyanate (TDI) or mixtures thereof, isophorone diisocyanate (IPDI) or its oligomers, hexamethylene diisocyanate (HDI) or its oligomers, or mixtures thereof. The preferably used isocyanates may also comprise uretdione, allophanate, uretonimine, urea, biuret, isocyanurate or iminooxadiazinetrione groups. Further possible isocyanates are specified for example in “Kunststoffhandbuch, volume 7, Polyurethane”, Carl Hanser Verlag, 3rd edition 1993, chapters 3.2 and 3.3.2.

Polyisocyanate (a) is preferably used in the form of polyisocyanate prepolymers. These polyisocyanate prepolymers are obtainable by reacting above-described polyisocyanates (a1), for example at temperatures of 30 to 100° C., preferably at about 80° C., with polyols (a2) to form the prepolymer. The prepolymers of the present invention are preferably obtained using polyols based on polyesters, for example by proceeding from adipic acid, or polyethers, for example by proceeding from ethylene oxide and/or propylene oxide.

Polyols (a2) are known to a person skilled in the art and are described for example in “Kunststoffhandbuch, 7, Polyurethane”, Carl Hanser Verlag, 3rd edition 1993, chapter 3.1. Preference for use as polyols (a2) is given to using comparatively high molecular weight compounds having at least two reactive hydrogen atoms, as described under (b).

Optionally, chain-extending agents (a3) can further be added to the reaction to form the polyisocyanate prepolymer. Useful chain-extending agents (a3) for the prepolymer include di- or trihydric alcohols, for example dipropylene glycol and/or tripropylene glycol, or the adducts of alkylene oxides, preferably propylene oxide, with dipropylene glycol and/or tripropylene glycol.

The comparatively high molecular weight compound having at least two reactive hydrogen atoms (b) can be selected from the compounds known and customary for production of flexible polyurethane foams.

The compound having at least two active hydrogen atoms (b) preferably comprises polyester alcohols and/or polyether alcohols having a functionality of 2 to 8, especially 2 to 6, preferably 2 to 4 and an average equivalent molecular weight in the range from 400 to 10 000 g/mol, preferably 1000 to 4000 g/mol.

The polyether alcohols are obtainable in a known manner, usually by catalytic addition of alkylene oxides, especially ethylene oxide and/or propylene oxide, onto H-functional starter substances or by condensation of tetrahydrofuran. Useful H-functional starter substances include in particular polyfunctional alcohols and/or amines. Preference is given to using water, dihydric alcohols, for example ethylene glycol, propylene glycol, or butanediols, trihydric alcohols, for example glycerol or trimethylolpropane, and also more highly hydric alcohols, such as pentaerythritol and sugar alcohols, for example sucrose, glucose or sorbitol. The preferred amines are amines having up to 10 carbon atoms, for example aliphatic amines such as ethylenediamine, diethylenetriamine, propylenediamine, aromatic amines such as 2,3-tolylene-diamine, and also aminoalcohols, such as ethanolamine or diethanolamine. The alkylene oxides are preferably ethylene oxide and/or propylene oxide, while polyether alcohols used for producing flexible polyurethane foams frequently have an ethylene oxide block added at the chain end. Useful catalysts for the addition reaction of alkylene oxides include in particular basic compounds, and potassium hydroxide is industrially the most important one. It is also possible for the polyether alcohol used for preparing the prepolymer to be used in component b).

Flexible foams and integral foams are produced using in particular doubly and/or triply functional polyether alcohols.

Preferred polyether polyols are obtained by known methods, for example via anionic polymerization with alkali metal hydroxides or alkali metal alkoxides as catalysts and in the presence of at least one starter molecule comprising 2 to 3 isocyanate-reactive hydrogen atoms in bonded form, or via cationic polymerization with Lewis acids, such as antimony pentachloride or boron fluoride etherate from one or more alkylene oxides having 2 to 4 carbon atoms in the alkylene moiety. Suitable alkylene oxides include for example tetrahydrofuran, 1,3-propylene oxide, 1,2-butylene oxide and 2,3-butylene oxide, preferably tetrahydrofuran, ethylene oxide and 1,2-propylene oxide. The alkylene oxides can be used individually, alternatingly in succession or as mixtures. Preference is given to using mixtures of 1,2-propylene oxide and ethylene oxide where the ethylene oxide is used in amounts of 10 to 50% as EO-cap, so the resultant polyols generally have more than 70% primary OH end groups. Polytetrahydrofuran polyols are obtained by a cationic ring-opening polymerization of tetrahydrofuran, for example.

Useful starter molecules include water and 2- and 3-hydric alcohols, such as ethylene glycol, 1,2-propanediol, 1,3-propanediol, diethylene glycol, dipropylene glycol, 1,4-butanediol, glycerol or trimethylolpropane, preferably ethylene glycol, 1,2-propanediol, 1,3-propanediol, diethylene glycol, dipropylene glycol, tripropylene glycol and 1,4-butanediol.

Preferred polyether polyols generally have an average OH functionality of 1.5 to 3, preferably 1.6 to 2.9, more preferably 1.7 to 2.7 and in particular about 2, and molecular weights of 1000 to 12 000, preferably 1400 to 8000 g/mol and more preferably 1700 to 6000 g/mol.

The compound having at least two active hydrogen atoms may further preferably comprise polyester polyols, for example polyester polyols obtainable from organic dicarboxylic acids having 2 to 12 carbon atoms, preferably aliphatic dicarboxylic acids having 8 to 12 carbon atoms and polyhydric alcohols, preferably diols, having 2 to 12 carbon atoms, preferably 2 to 6 carbon atoms. Useful dicarboxylic acids include for example: succinic acid, glutaric acid, adipic acid, suberic acid, azelaic acid, sebacic acid, decanedicarboxylic acid, maleic acid, fumaric acid, phthalic acid, isophthalic acid, terephthalic acid and the isomeric naphthalenedicarboxylic acids. Use of adipic acid is preferred. The dicarboxylic acids can be used not only individually but also mixed with each other. Instead of the free dicarboxylic acids it is also possible to use the corresponding dicarboxylic acid derivatives, for example dicarboxylic esters of alcohols having 1 to 4 carbon atoms or dicarboxylic anhydrides.

Examples of di- and polyhydric alcohols, especially diols, are: ethanediol, diethylene glycol, 1,2-propanediol, 1,3-propanediol, dipropylene glycol, 1,4-butanediol, 1,5-pentanediol, 1,6-hexanediol, 1,10-decanediol, glycerol and trimethylolpropane. Preference is given to using ethanediol, diethylene glycol, 1,4-butanediol, 1,5-pentanediol, 1,6-hexanediol or mixtures of two or more of the diols mentioned, especially mixtures of 1,4-butanediol, 1,5-pentanediol and 1,6-hexanediol. It is further possible to use polyester polyols formed from lactones, e.g., E-caprolactone or hydroxy carboxylic acids, e.g., co-hydroxycaproic acid and hydroxybenzoic acids. Use of dipropylene glycol is preferred.

The hydroxyl number of the polyester alcohols is preferably in the range between 10 and 400 mg KOH/g.

Flexible polyurethane foams based on polyester alcohols are characterized by good biodegradability (rottability).

Useful polyols further include polymer-modified polyols, preferably polymer-modified polyesterols or polyetherols, more preferably graft polyetherols and graft polyesterols, especially graft polyetherols. A polymer-modified polyol is a so-called polymer polyol which typically has a, preferably thermoplastic, polymer content of 5 to 60 wt %, preferably 10 to 55 wt %, more preferably 30 to 55 wt % and in particular 40 to 50 wt %.

Polymer polyols are described for example in EP-A-250 351, DE 111 394, U.S. Pat. No. 3,304,273, U.S. Pat. No. 3,383,351, U.S. 3,523,093, DE 1 152 536 and DE 1 152 537 and are typically prepared by free-radical polymerization of suitable olefinic monomers, for example (meth)acrylates, (meth)acrylic acid and/or acrylamide, in a grafting-based polyol, preferably polyesterol or polyetherol. The side chains are generally formed by transfer of free radicals from growing polymer chains to polyols.

Polymer polyol in the comparatively high molecular weight compound (b) is preferably present therein together with further polyols, for example polyetherols, polyesterols or mixtures of polyetherols and polyesterols. The proportion of polymer polyol is more preferably greater than 5 wt %, based on the overall weight of component (b). The polymer polyols can be present for example in an amount of 7 to 90 wt % or of 11 to 80 wt %, based on the overall weight of component (b). It is particularly preferable for the polymer polyol to be polymer polyesterol or polymer polyetherol.

In general, the flexible polyurethane foam of the present invention is produced by reacting the polyisocyanates (a), the comparatively high molecular weight compounds having at least two reactive hydrogen atoms (b) and optionally chain-extending and/or crosslinking agents (c) in such amounts that the equivalence ratio of NCO groups in polyisocyanates (a) to the sum total of reactive hydrogen atoms in components (b) and optionally (c) and (e) is from 0.7 to 1.25:1, and preferably from 0.80 to 1.15:1. A ratio of 1:1 here corresponds to an isocyanate index of 100. The proportion of component (b) is preferably between 0.01 and 90 wt %, more preferably between 0.5 and 50 wt % and even more preferably between 0.7 and 30 wt %, based on the overall weight of components (a) to (f).

Substances used as chain-extending agents and/or crosslinking agents (c) have a molecular weight of preferably below 500 g/mol and more preferably in the range from 60 to 400 g/mol, with chain extenders having 2 isocyanate-reactive hydrogen atoms and crosslinkers having at least 3 isocyanate-reactive hydrogen atoms. These can be used individually or in the form of mixtures. Preference is given to using diols and/or triols having molecular weights of less than 400, more preferably in the range from 60 to 300 and especially in the range from 60 to 150. Possibilities include, for example, aliphatic, cycloaliphatic and/or araliphatic diols having 2 to 14, preferably 2 to 10 carbon atoms, such as ethylene glycol, 1,3-propanediol, 1,10-decanediol, o-, m-, p-dihydroxycyclohexane, diethylene glycol, dipropylene glycol and preferably 1,4-butane-diol, 1,6-hexanediol and bis(2-hydroxyethyl)hydroquinone, triols, such as 1,2,4-, and 1,3,5-trihydroxycyclohexane, glycerol and trimethylolpropane, and low molecular weight hydroxyl-containing polyalkylene oxides based on ethylene oxide and/or 1,2-propylene oxide and the aforementioned diols and/or triols as starter molecules. Monoethylene glycol, 1,4-butanediol and/or glycerol are particularly preferable for use as chain extenders (d).

Chain-extending agents, crosslinking agents or mixtures thereof, if used, are advantageously used in amounts of 1 to 60 wt %, preferably 1.5 to 50 wt % and in particular 2 to 40 wt %, based on the weight of components (b) and (c).

Catalysts (d) used for producing the polyurethane foams are preferably compounds having a substantial hastening effect on the reaction of the hydroxyl-containing compounds of component (b) and optionally (c) with the polyisocyanates (a). Examples are amidines, such as 2,3-dimethyl-3,4,5,6-tetrahydropyrimidine, tertiary amines, such as triethylamine, tributylamine, dimethylbenzylamine, N-methyl-, N-ethyl-, N-cyclohexylmorpholine, N,N,N′,N′-tetramethylethylenediamine, N,N,N′,N′-tetramethylbutanediamine, N,N,N′,N′-tetramethylhexanediamine, pentamethyldiethylenetriamine, tetramethyldiaminoethyl ether, bis(dimethylaminopropyl)urea, dimethylpiperazine, 1,2-dimethylimidazole, 1-azabicyclo(3,3,0)octane and preferably 1,4-diazabicyclo(2,2,2)octane and alkanolamine compounds, such as triethanolamine, triisopropanolamine, N-methyl- and N-ethyldiethanolamine and dimethylethanolamine. Also useful are organometallic compounds, organotin compounds, such as tin(II) salts of organic carboxylic acids, e.g., tin(II) acetate, tin(II) octanoate, tin(II) ethylhexoanate and tin(II) laurate and the dialkyltin(IV) salts of organic carboxylic acids, e.g., dibutyltin diacetate, dibutyltin dilaurate, dibutyltin maleate and dioctyltin diacetate, and also bismuth carboxylates, such as bismuth(III) neodecanoate, bismuth 2-ethylhexanoate and bismuth octanoate or mixtures thereof. The organometallic compounds can be used alone or in combination with strongly basic amines. However, metal catalysts are preferably disavowed in applications in contact with rainwater and natural soils in that exclusively organic or aminic catalysts are used. When component (b) is an ester, it is preferable to use amine catalysts only.

The amount of catalyst or catalyst combination used is preferably from 0.001 to 5 wt % and especially from 0.05 to 2 wt %, based on the weight of components (b), (c) and (d).

Polyurethane foams are produced in the further presence of blowing agents (e). Chemically acting blowing agents and/or physically acting compounds can be used as blowing agents (e). Chemical blowing agents are compounds which react with isocyanate to form gaseous products, water being an example. Physical blowing agents are compounds which are in a dissolved or emulsified state in the polyurethane production ingredients and vaporize under the conditions of polyurethane formation. Examples are hydrocarbons, halogenated hydrocarbons, and other compounds, for example perfluorinated alkanes, such as perfluorohexane, hydrochlorofluorocarbons, and ethers, esters, ketones and/or acetals, for example (cyclo)aliphatic hydrocarbons having 4 to 8 carbon atoms, hydrofluorocarbons, such as Solkane® 365 mfc, or gases, such as carbon dioxide. One embodiment uses a mixture of these blowing agents which comprises water. If water is not used as blowing agent, it is preferable to use physical blowing agents only.

The level of physical blowing agents (e) is in one preferred embodiment in the range between 1 and 20 wt %, especially 5 and 20 wt %, the amount of water is preferably in the range between 0.5 and 10 wt %, especially 1 and 5 wt %.

It is particularly preferable to use water as blowing agent (e).

Auxiliaries and/or added-substance materials (f) are, for example, surfactants, foam stabilizers, cell regulators, external and internal release agents, fillers, pigments, optionally hydrolysis control agents and also fungistats and bacteristats provided they do not impair plant growth.

Preferably, however, no hydrolysis control agents, fungistats or bacteristats are used. As a result, easily rottable flexible polyurethane foams are obtained in combination with aliphatic polyester polyols based on ethylene glycols, for example.

Polyurethane foams are customarily produced in industry by combining the compounds having at least two active hydrogen atoms (b) and one or more of the ingredients (c) to (f), unless already used for preparing the polyisocyanate prepolymers into a so-called polyol component before the reaction with the polyisocyanate (a).

To produce the polyurethanes of the present invention, the organic polyisocyanates are reacted with the compounds having at least two active hydrogen atoms in the presence of the recited blowing agents, catalysts and auxiliary and/or added-substance materials (polyol component).

In general, the flexible polyurethane foam of the present invention is produced by reacting the polyisocyanates (a), the comparatively high molecular weight compounds having at least two reactive hydrogen atoms (b) and optionally chain-extending and/or crosslinking agents (c) in such amounts that the equivalence ratio of NCO groups in polyisocyanates (a) to the sum total of reactive hydrogen atoms in components (b) and optionally (c) and (e) is from 0.7 to 1.25:1, and preferably from 0.80 to 1.15:1. A ratio of 1:1 here corresponds to an isocyanate index of 100.

The polyurethane foams are preferably produced by the one-shot process, for example using high-pressure or low-pressure technology. The foams can be produced in open or closed metallic molds or by the continuous application of the reaction mixture to belt lines for production of slabstock foam or continuous-sheet foam.

It is particularly advantageous to proceed according to the so-called two-component method wherein, as elaborated above, a polyol component is prepared and foamed with polyisocyanate (a). The components are generally mixed, and introduced into the mold/applied to the belt line, at a temperature of 15 to 80° C. The temperature in the mold is generally in the range between 15 and 80° C., preferably between 30 and 60° C.

In one preferred embodiment of the invention, the plant seeds (g) are dispersed in the reactive polyurethane foam mixture even as it is being mixed from components (a) to (f). More particularly, the plant seeds are admixed to the polyol component formed from the ingredients (b) to (f).

In a further embodiment, they are introduced into the mold and mixed with the reactive polyurethane foam mixture. For example, they can be scattered across the floor of the mold or be scattered onto the reactive mixture present in the mold or the belt line.

In one preferred embodiment, the flexible polyurethane foam comprises a reinforcing fabric composed of fibers. The incorporation of coarse reinforcing fabrics in the foam makes it possible to improve the load-bearing capacity and tensile strength of the foam mats. Reinforcing fabrics can consist of synthetic-polymer fibers or of natural fibers. In one embodiment, the flexible polyurethane foam comprises a reinforcing fabric composed of synthetic-polymer fibers, for example polypropylene, polyethylene or polyimide fibers. In a further embodiment, the flexible polyurethane foam comprises a reinforcing fabric composed of rottable natural fibers, for example sisal fibers, coir mats, hemp fabrics or flax fabrics.

The flexible polyurethane foams of the present invention may comprise a further component (h) in substances having high water-holding capacity. Examples are polyacrylate-based superabsorbents. These can be mixed with components (a) to (g) in the mix head, or be applied in admixture with the seeds, in the production of the flexible polyurethane foams.

Substances having high water-holding capacity (h) are in particular polymers of (co)polymerized hydrophilic monomers such as for example partially neutralized acrylic acid, 2-hydroxyethyl methacrylate and 2-hydroxyethyl acrylate, graft (co)polymers of one or more hydrophilic monomers on a suitable grafting base, crosslinked ethers of cellulose or of starch, crosslinked carboxymethylcellulose, partially crosslinked polyalkylene oxide, partially crosslinked polyvinylpyrrolidone or polyvinylpyrrolidone copolymers, or natural products swellable in aqueous fluids, examples being guar derivatives or bentonites, of which water-absorbing polymers (f) based on partially neutralized acrylic acid are preferred. Such polymers are used as absorbent products for producing diapers, tampons, sanitary napkins and other hygiene articles, but also as water-retaining agents in market gardening.

The production of water-absorbing polymers (h) is described for example in the monograph “Modern Superabsorbent Polymer Technology”, F. L. Buchholz and A. T. Graham, Wiley-VCH, 1998, or in Ullmann's Encyclopedia of Industrial Chemistry, 6th edition volume 35 pages 73 to 103. The preferred method of making is the solution or gel polymerization process. In this process, the first step is to prepare a monomer mixture which is batch neutralized and then transferred into a polymerization reactor, or is already present in the polymerization reactor as an initial charge. The subsequent batch or continuous operation includes the reaction to form the polymer gel, which in the case of a stirred polymerization is already comminuted. The polymer gel is subsequently dried, ground and sieved and then transferred for further surficial treatment.

The water-absorbing polymers are obtained for example by polymerization of a monomer solution comprising

aa) at least one ethylenically unsaturated carboxylic acid and/or sulfonic acid,

bb) at least one crosslinker,

cc) selectively one or more ethylenically and/or allylically unsaturated monomers copolymerizable with the monomer aa) and

dd) selectively one or more water soluble polymers onto which the monomers aa), bb) and if appropriate cc) can be at least partly grafted.

Useful ethylenically unsaturated carboxylic acids and sulfonic acids aa) include for example acrylic acid, methacrylic acid, maleic acid, fumaric acid, crotonic acid, 4-pentenoic acid, 2-acrylamide-2-methylpropanesulfonic acid, vinylsulfonic acid, 3-allyoxy-2-hydroxypropane-1-sulfonate and itaconic acid. Acrylic acid and methacrylic acid are particularly preferred monomers. Acrylic acid is very particularly preferred.

The monomers aa) and especially acrylic acid comprise preferably up to 0.025% by weight of a hydroquinone half ether. Preferred hydroquinone half ethers are hydroquinone monomethyl ether (MEHQ) and/or tocopherols.

RRR-alpha-tocopherol is preferred in particular.

The monomer solution comprises preferably not more than 130 weight ppm, more preferably not more than 70 weight ppm, preferably not less than 10 weight ppm, more preferably not less than 30 weight ppm and especially about 50 weight ppm of hydroquinone half ether, all based on acrylic acid, with acrylic acid salts being counted as acrylic acid. For example, the monomer solution can be produced using an acrylic acid having an appropriate hydroquinone half ether content. The crosslinkers bb) are compounds having at least two polymerizable groups which can be free-radically interpolymerized into the polymer network. Suitable crosslinkers bb) are for example ethylene glycol dimethacrylate, diethylene glycol diacrylate, allyl methacrylate, trimethylolpropane triacrylate, triallylamine, tetraallyloxyethane, as described in EP-A-0 530 438, di- and triacrylates, as described in EP-A-0 547 847, EP-A-0 559 476, EP-A-0 632 068, WO 93/21237, WO 03/104299, WO 03/104300, WO 03/104301 and DE-A-103 31 450, mixed acrylates which, as well as acrylate groups, comprise further ethylenically unsaturated groups, as described in DE-A-103 31 456 and WO 04/013064, or crosslinker mixtures as described for example in DE-A-195 43 368, DE-A-196 46 484, WO 1990/15830 and WO 02/32962.

Useful crosslinkers bb) include in particular N,N′-methylenebisacrylamide and N,N′-methylenebismethacrylamide, esters of unsaturated mono- or polycarboxylic acids of polyols, such as diacrylate or triacrylate, for example butanediol diacrylate, butanediol dimethacrylate, ethylene glycol diacrylate, ethylene glycol dimethacrylate and also trimethylolpropane triacrylate and allyl compounds, such as allyl (meth)acrylate, triallyl cyanurate, diallyl maleate, polyallyl esters, tetraallyloxyethane, triallylamine, tetraallyl-ethylenediamine, allyl esters of phosphoric acid and also vinylphosphonic acid derivatives as described for example in EP-A-0 343 427. Useful crosslinkers bb) further include pentaerythritol diallyl ether, pentaerythritol triallyl ether, pentaerythritol tetraallyl ether, polyethylene glycol diallyl ether, ethylene glycol diallyl ether, glycerol diallyl ether, glycerol triallyl ether, polyallyl ethers based on sorbitol, and also ethoxylated variants thereof. The process of the invention utilizes di(meth)acrylates of polyethylene glycols, the polyethylene glycol used having a molecular weight between 300 and 1000.

However, particularly advantageous crosslinkers bb) are di- and triacrylates of 3- to 15-tuply ethoxylated glycerol, of 3- to 15-tuply ethoxylated trimethylolpropane, of 3- to 15-tuply ethoxylated trimethylolethane, especially di- and triacrylates of 2- to 6-tuply ethoxylated glycerol or of 2- to 6-tuply ethoxylated trimethylolpropane, of 3-tuply propoxylated glycerol, of 3-tuply propoxylated trimethylolpropane, and also of 3-tuply mixedly ethoxylated or propoxylated glycerol, of 3-tuply mixedly ethoxylated or propoxylated trimethylolpropane, of 15-tuply ethoxylated glycerol, of 15-tuply ethoxylated trimethylolpropane, of 40-tuply ethoxylated glycerol, of 40-tuply ethoxylated trimethylolethane and also of 40-tuply ethoxylated trimethylolpropane.

Very particularly preferred for use as crosslinkers bb) are diacrylated, dimethacrylated, triacrylated or trimethacrylated multiply ethoxylated and/or propoxylated glycerols as described for example in WO 03/104301. Di- and/or triacrylates of 3- to 10-tuply ethoxylated glycerol are particularly advantageous. Very particular preference is given to di- or triacrylates of 1- to 5-tuply ethoxylated and/or propoxylated glycerol. The triacrylates of 3- to 5-tuply ethoxylated and/or propoxylated glycerol are most preferred. These are notable for particularly low residual levels (typically below 10 weight ppm) in the water-absorbing polymer and the aqueous extracts of water-absorbing polymers produced therewith have an almost unchanged surface tension (typically not less than 0.068 N/m) compared with water at the same temperature. Examples of ethylenically unsaturated monomers cc) which are copolymerizable with the monomers aa) are acrylamide, methacrylamide, crotonamide, dimethylaminoethyl methacrylate, dimethylaminoethyl acrylate, dimethylaminopropyl acrylate, diethylaminopropyl acrylate, dimethylaminobutyl acrylate, dimethylaminoethyl methacrylate, diethylaminoethyl methacrylate, dimethylaminoneopentyl acrylate and dimethylaminoneopentyl methacrylate.

Useful water-soluble polymers dd) include polyvinyl alcohol, polyvinylpyrrolidone, starch, starch derivatives, polyglycols, in particular dihydric and trihydric polyols based on ethylene oxide and/or propylene oxide, or polyacrylic acids, preferably polyvinyl alcohol, polyglycols and starch.

The preferred polymerization inhibitors require dissolved oxygen for optimum performance. Typically, the monomer solutions are freed of dissolved oxygen prior to polymerization by inertization, e.g., by flowing an inert gas, preferably nitrogen, through them. This distinctly weakens the effect of the polymerization inhibitors. The oxygen content of the monomer solution is preferably lowered to less than 1 weight ppm and more preferably to less than 0.5 weight ppm prior to polymerization. The preparation of a suitable base polymer and also further useful hydrophilic ethylenically unsaturated monomers dd) are described in DE-A-199 41 423, EP-A-0 686 650, WO-A-01/45758 and WO-A-03/104300.

Water-absorbing polymers are typically obtained by addition polymerization of an aqueous monomer solution with or without subsequent comminution of the hydrogel. Suitable methods of making are described in the literature. Water-absorbing polymers are obtainable for example by gel polymerization in the batch process or tubular reactor and subsequent comminution in meat grinder, extruder or kneader (EP-A-0 445 619, DE-A-198 46 413), addition polymerization in kneader with continuous comminution by contrarotatory stirring shafts for example (WO-A-01/38402), addition polymerization on belt and subsequent comminution in meat grinder, extruder or kneader (DE-A-38 25 366, U.S. Pat. No. 6,241,928), emulsion polymerization, which produces bead polymers having a relatively narrow gel size distribution (EP-A-0 457 660), in situ addition polymerization of a woven fabric layer which, usually in a continuous operation, has previously been sprayed with aqueous monomer solution and subsequently been subjected to a photopolymerization (WO 2002/94328, WO 2002/94329).

The reaction is preferably carried out in a kneader as described for example in WO-A-01/38402, or on a belt reactor as described for example in EP-A-0 955 086. Neutralization can also be carried out to some extent after polymerization, at the hydrogel stage. It is therefore possible to neutralize up to 40 mol %, preferably from 10 to 30 mol % and more preferably from 15 to 25 mol % of the acid groups before polymerization by adding a portion of the neutralizing agent to the monomer solution and setting the desired final degree of neutralization only after polymerization, at the hydrogel stage. The monomer solution can be neutralized by admixing the neutralizing agent. The hydrogel may be mechanically comminuted, for example by means of a meat grinder, in which case the neutralizing agent can be sprayed, sprinkled or poured on and then carefully mixed in. To this end, the gel mass obtained can be repeatedly meat-grindered for homogenization. Neutralization of the monomer solution to the final degree of neutralization is preferred.

The neutralized hydrogel is then dried with a belt or drum dryer until the residual moisture content is preferably below 15% by weight and especially below 10% by weight, the water content being determined by EDANA (European Disposables and Nonwovens Association) recommended test method No. 430.2-02 “Moisture content”. Selectively, drying can also be carried out using a fluidized bed dryer or a heated plowshare mixer. To obtain particularly white products, it is advantageous to dry this gel by ensuring rapid removal of the evaporating water. To this end, the dryer temperature must be optimized, the air feed and removal has to be policed, and at all times sufficient venting must be ensured. Drying is naturally all the more simple—and the product all the more white—when the solids content of the gel is as high as possible. The solids content of the gel prior to drying is therefore preferably between 30% and 80% by weight. It is particularly advantageous to vent the dryer with nitrogen or some other nonoxidizing inert gas. Selectively, however, simply just the partial pressure of the oxygen can be lowered during drying to prevent oxidative yellowing processes. But in general adequate venting and removal of the water vapor will likewise still lead to an acceptable product. A very short drying time is generally advantageous with regard to color and product quality.

The dried hydrogel is preferably ground and sieved, useful grinding apparatus typically including roll mills, pin mills or swing mills. The particle size of the sieved, dry hydrogel is preferably below 1000 μm, more preferably below 800 μm and most preferably below 600 μm and preferably above 10 μm, more preferably above 50 μm and most preferably above 100 μm.

Very particular preference is given to a particle size (sieve cut) in the range from 106 to 850 μm. The particle size is determined according to EDANA (European Disposables and Nonwovens Association) recommended test method No. 420.2-02 “Particle size distribution”. The base polymers are then preferably surface postcrosslinked. Useful postcrosslinkers are compounds comprising two or more groups capable of forming covalent bonds with the carboxylate groups of the hydrogel. Suitable compounds are for example alkoxysilyl compounds, polyaziridines, polyamines, polyamidoamines, di- or polyglycidyl compounds, as described in EP-A-0 083 022, EP-A-0 543 303 and EP-A-0 937 736, di- or polyfunctional alcohols, as described in DE-C-33 14 019, DE-C-35 23 617 and EP-A-0 450 922, or β-hydroxyalkylamides, as described in DE-A-102 04 938 and U.S. Pat. No. 6,239,230. Useful surface postcrosslinkers are further said to include by DE-A-40 20 780 cyclic carbonates, by DE-A-198 07 502 2-oxazolidone and its derivatives, such as 2-hydroxyethyl-2-oxazolidone, by DE-A-198 07 992 bis- and poly-2-oxazolidinones, by DE-A-198 54 573 2-oxotetrahydro-1,3-oxazine and its derivatives, by DE-A-198 54 574 N-acyl-2-oxazolidones, by DE-A-102 04 937 cyclic ureas, by DE-A-103 34 584 bicyclic amide acetals, by EP-A-1 199 327 oxetanes and cyclic ureas and by WO 03/031482 morpholine-2,3-dione and its derivatives. Postcrosslinking is typically carried out by spraying a solution of the surface postcrosslinker onto the hydrogel or onto the dry base polymeric powder. After spraying, the polymeric powder is thermally dried, and the crosslinking reaction may take place not only before but also during drying.

The spraying with a solution of the crosslinker is preferably carried out in mixers having moving mixing implements, such as screw mixers, paddle mixers, disk mixers, plowshare mixers and shovel mixers. Particular preference is given to vertical mixers and very particular preference to plowshare mixers and shovel mixers. Contact dryers are preferable, shovel dryers more preferable and disk dryers most preferable as apparatus in which thermal drying is carried out. Fluidized bed dryers can be used as well. Drying may take place in the mixer itself, by heating the jacket or introducing a stream of warm air. It is similarly possible to use a downstream dryer, for example a tray dryer, a rotary tube oven or a heatable screw. But it is also possible for example to utilize an azeotropic distillation as a drying process. Preferred drying temperatures are in the range from 50 to 250° C., preferably in the range from 50 to 200° C. and more preferably in the range from 50 to 150° C. The preferred residence time at this temperature in the reaction mixer or dryer is below 30 minutes and more preferably below 10 minutes.

The flexible polyurethane foams of the present invention may comprise a further component (i) in nutrients. Examples are fertilizing compositions based on mineral fertilizers, nitrogen compounds and phosphorus compounds and also trace elements. These can be mixed with components (a) to (g), or preferably be applied in admixture with the seeds, in the production of the flexible polyurethane foams, in encapsulated form.

The flexible polyurethane foams of the present invention may further comprise a foamed-in drainage system, which may be constructed for example of thin-wall perforated polyethylene or polypropylene tubing and is preferably incorporated in the foam in conjunction with the reinforcing agents.

Examples of plant seeds are the seeds of grasses, mosses, lichens, ferns, aquatic plants, flowering plants and also perennial woody plants, such as bushes, shrubs, tendrils, ivy and vines. Spores, for example of fungi, lichens and mosses, also count as seeds.

The present invention also provides a method of vegetating areas, which comprises a flexible polyurethane foam in the form of a finite or continuous sheet being laid on the area or firmly bonded thereto and irrigated. The finite or continuous sheets are generally from 0.5 to 10 cm, preferably from 1 to 5 cm, for example from 2 to 3 cm, in thickness. They are obtainable by cutting polyurethane slabstock foam to size or by direct production of continuous sheets of polyurethane foam on a belt line.

Areas capable of being vegetated by the method of the present invention include, for example, exteriors, roof areas, rocky ground, sound-absorbing barriers and desert floors.

In one preferred embodiment, a flexible polyurethane foam of the present invention, comprising viable or already germinated lawn seed, is used as a substitute for rolled sod.

On areas where seeds cannot find any hold and applied soils are quickly blown away, for example concrete roofs, rocky ground and erosion areas, initial colonization with plants can be achieved using a seed mat a few cm, for example 2-3 cm, in thickness, since the seeds prior to germination cannot be carried away by wind or rain prior to germination. The mats are immobilized on the ground, for example by adhering or bolting. The open-cell flexible foam with its spongelike constitution further promotes the deposition of very small particles and dusts, such as dead plant parts, seeds, spores, loam dust and mineral dust and thus promotes the buildup of a layer comprising nutrients and capable of root penetration.

The flexible foam mats comprising plant seeds should not rot down too quickly when used for a pioneering plantation or desert vegetation. Preference is given to (hydrolysis-resistant) flexible polyurethane foams based on polyetherols. These are preferably covered with a layer of sand in order that the root system may thereby be given some protection from temperature fluctuations. In addition to a reinforcing fabric composed of nylon, polypropylene or sisal fibers, a drainage system can also be foamed into the flexible polyurethane foam to assume the water-supply function later. Superabsorbents, for example superabsorbents based on polyacrylates, can be admixed to the foam for superior water-holding capacity. These superabsorbents are preferably applied in admixture with the seeds or fixed beforehand to or in the reinforcing mesh. The seed mats can be installed in stripwise fashion, the interspaces being closed later by the plant growth or newly sown plants.

The examples which follow illustrate the invention.

### EXAMPLES

### Examples 1-7

The inventive materials were produced in the lab using a blender. Flexible polyurethane foam system versions with lawn seed were each combined in two methods of fabrication. Commercially available lawn seed was used. The seeds are viable after processing and grow out of the foam.

### Example 1

### Production Mode A

The lawn seeds were distributed on top of the reacting flexible polyurethane foam and sank into it to some extent. For this, 54.2 parts by weight of the polyether-based A component were mixed with 25.8 parts of the isocyanate-containing B component using a laboratory stirrer for 6 seconds. The still liquid reaction mixture was poured into a heat- and adherence-resistant dish and distributed therein until smooth. 20 parts by weight of lawn seeds were uniformly distributed onto the risen and still reacting foam. After one day, the fully cured foam with the seeds adherent therein and thereon was drenched with water and stored in a greenhouse atmosphere. Just 6 days later, the seed begins to germinate, and a dense lawn grows on the foam. The foam, which is up to 30 millimeters in thickness, is penetrated by the lawn roots and is able to store moisture.

### Production Mode B

The lawn seeds were stirred directly into the flexible polyurethane foam. For this, 52.1 parts by weight of the polyether-based A component were premixed with 23 parts by weight of the isocyanate-containing B component for 4 seconds, after which 24.9 parts by weight of lawn seeds were added, followed by further mixing for 3 seconds. The still liquid reaction mixture was poured into a heat- and adherence-resistant dish and distributed until smooth. The flexible foam produced contained a homogeneous distribution of lawn seeds. After one day, the fully cured combination foam was drenched with water and stored in a greenhouse atmosphere. Just 6 days later, the seed begins to germinate, and a dense lawn grows on the foam. The foam, which is up to 30 millimeters in thickness, is penetrated by the lawn roots and is able to store moisture.

The additional inventive examples 2 to 7 were produced in the same way as described in example 1. The exact compositions of the formulations are itemized in table 1.

In examples 5-7, in order to improve moisture storage, a superabsorbent additive was stirred directly into the reaction mixture as an added-substance material, prior to the foaming.

| | Example 1 | Example 2 | Example 3 | Example 4 |
|---|---|---|---|---|
| Polyol 1 | 3.11 | 30.94 | 10.65 | 40.85 |
| Polyol 2 | 48.78 | | | |
| Polyol 3 | | | | 10.53 |
| Polyol 4 | | 5.40 | | 4.09 |
| Polyol 5 | | 13.50 | 43.78 | |
| Polyol 6 | | | 0.96 | |
| Blowing agent | 1.72 | 3.24 | 0.68 | 0.70 |
| Stabilizer 1 | | 0.54 | | |
| Stabilizer 2 | 0.26 | 0.11 | 0.34 | |
| Stabilizer 3 | | | | 0.70 |
| Stabilizer 4 | | | 0.17 | |
| Catalyst 1 | 0.31 | 0.22 | | 0.20 |
| Catalyst 2 | 0.05 | | | |
| Catalyst 3 | | | 0.17 | |
| Catalyst 4 | | | | 0.06 |
| Isocyanate 1 | 12.93 | 13.08 | | 11.43 |
| Isocyanate 2 | 8.55 | 8.65 | | 7.54 |
| Isocyanate 3 | 4.28 | 4.33 | 19.13 | 3.89 |
| Isocyanate 4 | | | 1.45 | |
| Additive 1 | | | 2.67 | |
| Additive 2 | | | | |
| Additive 3 | | | | |
| Lawn seed | 20 | 20 | 20 | 20 |
| Total | 100.00 | 100.00 | 100.00 | 100.00 |

| | Example 5 | Example 6 | Example 7 |
|---|---|---|---|
| Polyol 1 | 2.93 | 29.11 | 9.47 |
| Polyol 2 | 45.90 | | |
| Polyol 3 | | | |
| Polyol 4 | | 5.08 | |
| Polyol 5 | | 12.70 | 38.92 |
| Polyol 6 | | | 0.85 |
| Blowing agent | 1.62 | 3.05 | 0.60 |
| Stabilizer 1 | | 0.51 | |
| Stabilizer 2 | 0.24 | 0.10 | 0.30 |
| Stabilizer 3 | | | |
| Stabilizer 4 | | | 0.15 |
| Catalyst 1 | 0.29 | 0.20 | |
| Catalyst 2 | 0.05 | | |
| Catalyst 3 | | | 0.15 |
| Catalyst 4 | | | |
| Isocyanate 1 | 12.17 | 12.31 | |
| Isocyanate 2 | 8.05 | 8.14 | |
| Isocyanate 3 | 4.03 | 4.07 | 17.01 |
| Isocyanate 4 | | | 1.29 |
| Additive 1 | | | |
| Additive 2 | 5 | | |
| Additive 3 | | 5 | 10 |
| Lawn seed | 20 | 20 | 20 |
| Total | 100.00 | 100.00 | 100.00 |

Key:
Polyol 1: Polyethylene glycol with an average molecular weight (MW) of 3550 g/mol
Polyol 2: Polypropylene glycol with an average molecular weight (MW) of 5390 g/mol
Polyol 3: Polypropylene glycol with an average molecular weight (MW) of 1970 g/mol
Polyol 4: Biobased polyetherpolyol with an average molecular weight (MW) of 3000 g/mol
Polyol 5: Polyesterdiol with an average molar mass of 2000 g/mol
Polyol 6: Monoethylene glycol with an average molecular weight (MW) of 62 g/mol
Blowing agent: Water
Stabilizer 1: Polyether-siloxane copolymer
Stabilizer 2: Organomodified siloxane polyether
Stabilizer 3: Polysiloxane-polyether copolymer
Stabilizer 4: Polymer based on carbodiimide and polyglycol ether
Catalyst 1: Triethylenediamine dissolved in 67 parts by weight of dipropylene glycol
Catalyst 2: Bis-2-dimethylaminoethyl ether dissolved in 30 parts by weight of dipropylene glycol
Catalyst 3: N-Methyl-N-(dimethylaminomethyl)piperazine
Catalyst 4: 3-(Dimethylamino)propylamine
Isocyanate 1: Monomeric 2,4-/4,4-diphenylmethane diisocyanate with an average molar mass of 250 g/mol and a functionality of 2
Isocyanate 2: Polymeric methylene diphenylene diisocyanate with an average molar mass of 337 g/mol and a functionality of 2.7
Isocyanate 3: Monomeric 4,4-diphenylmethane diisocyanate with an average molar mass of 250 g/mol and a functionality of 4,4-diphenylmethane diisocyanate
Isocyanate 4: Carbodiimide-modified monomeric 4,4-diphenylmethane diisocyanate having an isocyanate content of 29.5 parts by weight
Additive 1: gamma-Butyrolactone with an average molar mass of 86 g/mol
Additive 2: Luquasorb ® 1010 superabsorbent from BASF AG
Additive 3: Luquasorb ® 1060 superabsorbent from BASF AG
Lawn seed: Lawn seed from Kiepenkerl

### Example 8

### Exterior Wall Vegetation

An open-cell flexible polyether foam is formed into finite or continuous foam sheets about 2 cm in thickness which, to improve their mechanical strength, contain a supporting scaffold of fused nylon fabric. The nylon fabric is laid out on the floor of the foam mold before the actual foaming process and becomes enveloped during foaming by the reacting polyurethane mixture, forming a kind of skeleton in the flexible foam after it has been produced. The seeds or spores to be incorporated are added directly to the stirrer or the mix head in the course of the production of the polyurethane mix. If this is not possible because of the size of the seeds, the seeds can alternatively be distributed or scattered on the floor of the foam mold in accordance with the supporting fabric so that they also become enveloped by the reaction mixture and become included therein.

The seed-containing continuous polyurethane sheets are applied directly to the building exterior or fixed to a scaffold about 1 m in front of the exterior in order that an air/shade layer may be retained between the building and the cladding. A drip irrigation system at the upper edge of the cladding irrigates the foam sheets directly, ensuring adequate watering to germinate and sustain the plants. It is alternatively possible to use xerophytes, mosses or lichens which are not in need of a regular supply of water. When the foam sheets are applied directly to the exterior surface of the building, a moisture barrier in the form of a water-impermeable foil or film may be needed and it can optionally be applied to the underside of the foam sheets as they are being produced. The supply with plant nutrients in the exterior wall application may preferably be ensured via the irrigation water.

### Example 9

### Rolled-Sod Substitute

Finite or continuous sheets about 1 cm in thickness of an open-cell flexible polyester foam without hydrolysis stabilization are cut out of a thicker slabstock foam. To improve its mechanical strength, the flexible foam may comprise a rottable sisal fabric in foamed-in form. the grass seeds to be incorporated are directly introduced into the stirrer or the mix head in the course of the production of the polyurethane mix and distributed therein as uniformly as possible. The seed mats obtained can be laid directly on the lawn surface to be prepared and optionally covered with a thin layer of earth and watered. In another form of use, they are pregerminated to such an extent that a lawn about 5 cm in length has formed on them and the foam mat is already penetrated by grass. The mats are then applied in the manner of rolled sod, for which a supporting fabric may be advantageous to facilitate transportation.

### Example 10

### Moisture Imbibition

Identically sized moldings of examples 2, 6 and 7 were conditioned for 24 hours at room temperature and 50% relative humidity. Their water vapor imbibition was then determined at 40° C. and 90% relative humidity. The values obtained are reported in Table 2.

TABLE 2
Water vapor imbibition of produced moldings

| Time | Mass increase [wt %] | | |
|---|---|---|---|
| [min] | Example 2 | Example 3 | Example 4 |
| 120 | 1.5 | 6 | 7.5 |

1: A flexible polyurethane foam, comprising:
viable and/or germinated plant seeds, and
a substance having high water-holding capacity,
wherein the substance having high water-holding capacity is a polyacrylate-based superabsorbent.

2: The flexible polyurethane foam according to claim 1, comprising a reinforcing fabric composed of fibers.

3: The flexible polyurethane foam according to claim 2, comprising a reinforcing fabric composed of synthetic-polymer fibers.

4: The flexible polyurethane foam according to claim 2, comprising a reinforcing fabric composed of rottable natural fibers.

5-6. (canceled)

7: The flexible polyurethane foam according to claim 1, wherein the plant seeds are selected from the group consisting of seeds of grasses, mosses, lichens, ferns, fungi, aquatic plants, flowering plants, and perennial woody plants.

8: The flexible polyurethane foam according to claim 1, which is in a form of finite or continuous sheets of from 0.5 to 10 cm in thickness.

9: The flexible polyurethane foam according to claim 1, comprising a drainage system.

10: A method of producing flexible polyurethane foam, the method comprising:
mixing (a) polyisocyanates with (b) at least one comparatively high molecular weight compound comprising at least two reactive hydrogen atoms, (c) low molecular weight chain-extending agents and/or crosslinking agents, (d) catalysts, (e) blowing agents, (f) optionally other added-substance materials, (g) plant seeds, and (h) a further component comprising a substance having high water-holding capacity to obtain a mixture, and
reacting the mixture to form the flexible polyurethane foam comprising viable plant seeds,
wherein the substance having high water-holding capacity is a polyacrylate-based superabsorbent.

11: The method according to claim 10 wherein a reinforcing fabric composed of fibers is foamed into the flexible polyurethane foam.

12: The method according to claim 10, wherein the mixture obtained is introduced into a foaming mold or onto a belt system and cured to form the flexible polyurethane foam.

13: The method according to claim 12, wherein a reinforcing fabric composed of fibers is introduced into the foaming mold.

14. (canceled)

15: The method according to claim 10, wherein said reacting occurs at a temperature of not more than 80° C.

16: A method of vegetating areas, the method comprising:
laying on the areas or firmly bonding thereto the flexible polyurethane foam according to claim 1 in a form of a finite or continuous sheet, and
irrigating the flexible polyurethane foam.

17: The method according to claim 16, wherein the vegetating areas are vegetating exteriors, roof areas, rocky ground, sound-absorbing barriers, or desert floors.

18. (canceled)
